(19) United States
(12) Patent Application Publication
(10) Pub. No.: US 2004/0006148 A1
(43) Pub. Date: Jan. 8, 2004

(54) Processes and products for foaming thermoplastic materials using a pellet or powder as a vehicle to deliver a physical foaming agent, and products formed therewith

(75) Inventors: Richard E. Harris, Ravenne, OH (US); Hariharan Rajaraman, Munroe Falls, OH (US); Duane E. Peterson, Copley, OH (US)

Correspondence Address: OLIFF & BERRIDGE, PLC, P.O. BOX 19928, ALEXANDRIA, VA, 22320, US

(73) Assignee: POLYMER 5, Akron, OH (US)

(21) Appl. No.: 10/613,135

(22) Filed: Jul. 7, 2003

Related U.S. Application Data
(60) Provisional application No. 60/394,025, filed on Jul. 6, 2002.

(51) Int. Cl. C08J 9/00

(52) U.S. Cl. 521/50; 264/53

(57) ABSTRACT

In a process for forming low-density foamed articles, a blend of foamable thermoplastic material and physical foaming agent concentrate is mixed and melted and expanded to form an extruded foam article.

This nonprovisional application claims the benefit of U.S. Provisional Application No. 60/394,025 filed Jul. 6, 2002.

### BACKGROUND OF THE INVENTION

1. Field of Invention

This invention relates to processes and products for foaming thermoplastic materials using a pellet or powder containing a physical foaming agent, a physical foaming agent concentrate (PFAC) to introduce a physical foaming agent into a foaming process. It also relates to products formed therewith.

2. Description of Related Art

Foamed articles have been formed by the extrusion of thermoplastic materials including polyolefins, styrenics, thermoplastic elastomers (TPEs), thermoplastic vulcanizates (TPVs), thermoplastic urethanes (TPUs), Styrene-Ethylene-Butadiene-Styrene block copolymers (SEBS), Styrene-Butadiene-Styrene block copolymers (SBS), polyvinyl chlorides (PVCs), and fluoroelastomers, among others, using chemical blowing agents or physical blowing agents such as low-boiling hydrocarbons and chlorofluorocarbons. These processes have numerous disadvantages, including inefficiency and difficulty of use. In addition, many low-boiling hydrocarbons and chlorofluorocarbons are harmful to the ozone layer.

Environmentally safe foaming agents have been desired to address the disadvantages of chemical blowing agents. U.S. Pat. Nos. 5,070,111, 5,607,629 and 5,788,889 discuss the use of water as a physical blowing agent to produce low density foams. One approach for the use of water as a blowing agent has been to introduce water into the system by injecting the water into the thermoplastic melt under pressure. U.S. Pat. No. 5,567,370 specifically discloses such a process and apparatus for producing TPE foam profiles using water as a blowing agent.

U.S. Pat. No. 5,070,111 discloses the foaming of commercial thermoplastic elastomers such as those manufactured and sold by Advanced Elastomer Systems under the registered trademarks TREFSIN®, SANTOPRENE®, GEOLAST®, and VYRAM® among others. This process requires heating the thermoplastic elastomer to a temperature above its melting point using a single screw extruder equipped with a die. After the thermoplastic elastomer is melted, water is injected under pressure into the extruder. The water and melted thermoplastic elastomer are mixed, and the composition is then released to atmospheric pressure, usually through a shaping die, producing a foamed profile. U.S. Pat. No. 5,070,111 also discloses the use of 0.1 to 10% water to produce foams with low density, and good foam structure, in which the cells are fine and relatively uniform.

U.S. Pat. Nos. 5,070,111, 5,607,629 and 5,788,889 also disclose foaming of TPE using water, in a single screw extruder having a length to diameter ratio (L/D) of approximately 32:1. These patents also disclose an apparatus for metering the water into the barrel of the extruder. The foams produced by this apparatus have densities as low as 0.06g/cc, and have been produced using SANTOPRENE® TPV having a hardness of 64 Shore A. These patents indicate that water has a much greater efficiency than chlorofluorocarbons in developing cells in a TPE. Examples in these patents show that approximately 1500% more blowing agent by weight is required when CFC-11 (a chlorofluorocarbon) is used instead of water.

There are, however, difficulties associated with use of water-injected foam lines. Water-injected foam profiles require specialized extrusion equipment. This specialized water injection equipment is expensive and must be designed to deliver very precise amounts of water under a variety of processing conditions. For example, the precision pumps, such as gear pumps, that are generally used to accurately inject liquids cannot be used because of the unlubricated nature of the material being pumped. The quality of the water to be injected must be very high in order not to restrict the flow to the injector. In addition, the extrusion process itself can plug the injector, resulting in poor quality foam and/or equipment downtime.

U.S. Pat. No. 5,567,370 discloses a process and apparatus for producing TPE foam profiles, which involve heating the material in the extruder conveying section to a temperature between 180° and 210° C. at a pressure of 100-200 bar. Water is then injected into the melt at levels of up to 5% by weight of the TPE melt, and the resulting mixture is subsequently subjected to a two-stage shearing process. The two-stage shearing process produces a micro-fine distribution of water inside the melt and produces a foam profile with fine cell structure. However, several shortcomings exist with the process, including that the extrusion equipment required is extremely expensive and highly specialized. In most cases, a high L/D ratio is required—in the range of 32:1. In addition, an expensive 2-stage screw is required, preferably with a mixing section, in order to finely distribute the water within the polymer.

U.S. Pat. No. 6,242,502 reveals that the process of injecting liquid water has many limitations. The process requires special equipment for mixing ingredients and metering water, and the equipment itself is both expensive and cumbersome to use. Also, foam densities are sometimes difficult to control, and the process produces a non-uniform cell structure in the foam.

U.S. Pat. No. 6,242,502 introduces an alternative to water injection through the use of blending the TPE with a water-releasing chemical compound (WCC), heating the mixture to a temperature at which the WCC releases water (above the melting point of the TPE), and subsequently releases the heated mixture to atmospheric conditions. The use of aluminum tri-hydrate and magnesium hydroxide as water-releasing compounds is disclosed. U.S. Pat. No. 6,242,502 also introduces the use of a two-step process for producing foamed TPE, in which the TPE is compounded with a relatively large concentration (up to 30%) of WCC using a twin-screw extruder or continuous mixer, and the processed compound is then further processed into a foamed article by extrusion from a single screw extruder.

The disadvantages of this process for producing a foamed article are numerous. The procedure involves two significant processing steps, which can be expensive and complicated to practice. The composition of the water-releasing chemical compound can adversely affect physical properties of the finished articles and may produce by-products that that are detrimental to the process or finished article. A high concentration of WCC is required to achieve even moderate foam densities. Using the WCC as defined by U.S. Pat. No. 6,242,502 necessitates that the processing temperatures affect the amount of water liberated in the extrusion process. The temperatures required to liberate sufficient amounts of water for producing low-density foam are generally unfavorable compared with the optimized processing temperatures for the polymer being processed. In U.S. Pat. No. 6,242,502, the process conditions include temperatures up to 245° C., whereas optimum processing for the TPE is in the range of 190°-200° C. In addition, the quality of both the foam and “skin” of the foamed article is poor.

U.S. Pat. No. 6,110,404 discloses the use of a thermoplastic elastomer blended with water and introduced into the throat of an extruder. Specifically, pellets of the thermoplastic elastomer to be foamed and water are mixed, and then the water/pellet blend is transported to the extruder for processing. This process has many disadvantages as well, including that all of the thermoplastic material to be foamed must be soaked in water, in order to introduce a relatively small amount, 8% by weight, of water as a foaming agent into the extruder. The wet thermoplastic elastomer material is also difficult to handle, transport and store. In addition, the density of the foam is difficult to control, because there are multiple variables that affect the proportion of water to thermoplastic elastomer pellets, including humidity, length of storage and storage vessel configuration. Also, the quality of the foam and the output rates are adversely affected by the low extrusion screw speeds taught. In addition, recycling is difficult; in order to ensure that the individual materials remain in correct proportion, the blend of thermoplastic elastomer pellets and water must be dried or reblended, which makes the blend difficult to use in a manufacturing environment.

### SUMMARY OF THE INVENTION

Processes and products of the invention, in various embodiments, provide simple and economical solutions to many of the above difficulties. The selected thermoplastic material is blended with a Physical Foaming Agent Concentrate (PFAC) and fed into an extruder, which heats the mixture to above the melting point of the thermoplastic material. The PFAC comprises a pellet or powdered solid carrier containing a physical foaming agent, such as, for example, water, low boiling point hydrocarbons, or chlorofluorocarbons. The heat releases the physical foaming agent from the PFAC into the thermoplastic material. The mixture of thermoplastic material and physical foaming agent is then forced through a die. As the thermoplastic material/physical foaming agent blend is released to atmospheric pressure, a foamed article is generated.

### DETAILED DESCRIPTION OF EMBODIMENTS

Processes of the present invention can be used to foam any thermoplastic materials that are stable under foaming conditions, including but not limited to olefins, polyolefins, TPEs, TPVs, styrenics, metallocene compositions, SEBs, SEPS, SBS, polyvinyl chlorides, thermoplastic urethanes, COPE, COPA, and fluoroelastomers, among others, and mixtures thereof. The specific examples described below are described with reference to a thermoplastic elastomer, such as SANTOPRENE® TPV. SANTOPRENE® is the trade name of a thermoplastic vulcanizate, comprising a blend of olefin rubber and thermoplastic olefin resin in which the rubber is cured. SANTOPRENE® may be foamed to produce extruded tubing and profiles. The characteristics of SANTOPRENE® are described in U.S. Pat. Nos. 4,130,535 and 4,311,628. One embodiment of the invention uses a foamable grade of SANTOPRENE® 201-68W228 (Shore hardness 68A). This grade is particularly recommended for foaming using water. However, the invention is not limited in this respect and can be applied to other thermoplastic materials. Additionally, the present invention can include other ingredients for adjusting properties of the foamed article, including but not limited to fillers, waxes, colorants, and stabilizers, among others.

PFACs used in the claimed invention may be formed by combining a physical foaming agent (PFA) and a vehicle for delivering the PFA.

Any appropriate physical foaming agent may be used in processes of the invention, including, for example, water, low-boiling point hydrocarbons, hydrofluorocarbons or chlorofluorocarbons. Such physical foaming agents will be released from the PFAC at temperatures in the range of 0-350° C.; in embodiments, in the range of 10-350° C.; in embodiments, in the range of 80-250° C. The physical foaming agent can be combined with the PFAC vehicle in amounts from 1% to 90% by weight of the PFAC, for example, 5-85%, 10-80%, 20-70%, 30-60% or 40-50% by weight of the PFAC. Some carriers may suitably hold more than 100% by weight of the vehicle, for example 100-200% or more by weight of the vehicle.

Vehicles used for loading physical foaming agents according to the invention are preferably in the form of a solid carrier such as a pellet or powder, and can be any substance that is acceptably compatible with the thermoplastic material to be foamed and that can be loaded with physical foaming agent. High surface area materials, including but not limited to porous and microporous polymers based upon a variety of materials, are used in certain preferred embodiments of the invention. In embodiments, the pellet or powdered solid carrier may be chosen from thermoplastic materials such as polyolefins, styrenics, TPEs, TPVs, TPUs, SEBS, SBS, PVCs, and fluoroelastomers, among others. Appropriate polymeric vehicles also include super-absorbent polymeric materials, for example, polyacrylamides and polyacrylates. The vehicles may or may not be thermoplastic. In embodiments, the vehicles may be treated to be hydrophilic or hydrophobic. In embodiments, the pellet or powdered solid carrier may be chosen from organic or inorganic filler materials, such as silica. In embodiments, the vehicles may be made of the same material as the thermoplastic material to be foamed or a component thereof and thus may become homogeneously incorporated into the foamed article. Alternatively, the vehicles may include other materials or be made of different materials as desired, for example for cost purposes or to influence selected properties of the end products.

In embodiments, physical mechanisms are employed rather than chemically bonded systems. In embodiments, the vehicle is in the form of pellets or powdered solid carrier comprising microporous structures. Microporous structures behave like sponges, using capillary action to absorb liquid to several times their own weight. In this manner, a large amount of physical foaming agent relative to the weight of thermoplastic material can conveniently be used. The physical foaming agent can also be uniformly distributed throughout the mixture, and this allows for increased uniformity of the foam produced and better control of the characteristics of the foamed article.

In embodiments, vehicles in the form of pellets or powdered solid carrier can be prepared from microporous polymers. Both the pellet and powder forms of a microporous polymer can be free flowing and can be readily blended with the thermoplastic material to be foamed, for example prior to introduction to an extruder, without concern for material separation (stratification). Microporous polymers such as those manufactured by Membrana GmbH under the ACCUREL® trade name, such as ACCUREL® MP, which is a trade name used to identify a group of microporous products made from commercially available resins such as EVA, HDPE, LDPE, LLDPE, PP, PS, PET, polyamide, etc. ACCUREL® MP 100 loaded with water is particularly advantageous in foaming SANTOPRENE® TPV because PP is a basic component of the TPE and thus compatible with the SANTOPRENE® TPV. However, the invention is not restricted to PP-based ACCUREL® products. Depending on the thermoplastic material to be foamed, other microporous polymers, including but not limited to those based on EVA, LLDPE, HDPE, LDPE, PS, PET, polyamide, polyacrylamide, polyacrylate, etc., may be employed.

Thermoplastic material may be mixed with the PFAC according to the present invention, by any of many processes.

In embodiments, the PFAC is manufactured by blending the physical foaming agent in a suitable vehicle with a microporous polymer such as hydrophilic polypropylene. This blending operation can be carried out using a drum tumbler, a ribbon blender, or any other suitable mixer. This can be performed in a continuous or non-continuous (batch) process. In addition, the blending operation can be carried out with heat, cooling or at ambient temperature to ensure that (1) the physical foaming agent is absorbed or “loaded” into the PFAC vehicle as a liquid and (2) the temperature of the blending operation is lower than the melting point of the PFAC vehicle.

The PFAC can be combined with the thermoplastic material to be foamed in the range of 0.5% to 70% of the total amount of blended material, for example in the ranges of 1.0-50% PFAC, 2.0-40% PFAC, 2.5-30% PFAC, 4-20% PFAC, or 5-10% PFAC, by weight of the total amount of blended material. Thus, the physical foaming agent can be released in the range of 0.1-63% by weight relative to the weight of the total amount of blended material; in embodiments, 0.1-50% by weight of the total amount of blended material, in embodiments, 0.1-20% by weight of the total amount of blended material.

Once loaded with physical foaming agent and blended with the thermoplastic material to be foamed, the loaded vehicle will release the water or other physical foaming agent when the thermoplastic material and PFAC blend is heated above the melting point of the thermoplastic material.

The thermoplastic material to be foamed and PFAC can be blended to form a “dry blend”, either in a separate pre-blending operation or in situ. For example, the PFAC can be metered into an extruder at the same time as or separately from the thermoplastic material. Metering of the PFAC can be carried out, for example, by volumetric or gravimetric feeders. Such feeders are commonly used in extrusion and injection (or blow) molding operations.

The mixing of the thermoplastic material and PFAC generally takes place at any temperature between 0° C. and the temperature at which the PFAC starts to release from the vehicle—in the case of water below 100° C. Higher or lower temperatures can also be used with suitable controls to ensure that a PFA-containing vehicle is produced.

Chemical and physical blowing agents can be used in or in combination with the PFAC, allowing the foam to be tailored to a specific foam density, foam structure or manufacturing process.

Foaming processes of the present invention can be used in different forms, including but not limited to: extrusion; injection molding, thermoforming, blow molding, rotational molding, and foam casting. Foaming processes of the present invention can also be used for co-extrusion of foam parts with other foam or solid parts, for coating of foamed profiles with a solid polymer skin, which provides improved tear strength and low coefficient of friction, or with other variants.

Embodiments of the invention involve feeding a thermoplastic material and PFAC blend into the feed throat of an extruder (for example, a single screw-feed throat, or upstream/downstream port of a twin-screw extruder).

In the case of extrusion, the blend of thermoplastic material and PFAC polymer may be heated while being conveyed through an extruder equipped with a profile die. The physical foaming agent, such as water, is released from the PFAC and is dispersed uniformly inside the molten thermoplastic material. When the molten material containing the high temperature physical foaming agent, such as water, exits the die, the resultant pressure differential expands the thermoplastic material to create a foamed article.

The foaming process can be performed in any equipment that is known and suitable for foaming of a thermoplastic material. This can be carried out in a static process, as well as a continuous (or dynamic) process. In the first case, foaming to a predetermined shape (as in extrusion, injection, or blow molding), or thermoforming by the use of a heated shape (roto-molding) can be performed.

Standard single screw extruders with good temperature control may desirably be used to manufacture foamed articles. L/D ratios, for example 20:1 to 42:1 or longer, can be employed. General purpose screws with conventional compression ratios can be used. Screws configured with mixing and shearing sections may also be used in embodiments.

Foamed articles prepared by processes of the present invention can be used for many purposes, including but not limited to: weight reduction, vibration reduction, energy absorption, sealing, friction improvement, cushioning, insulation (thermal, acoustical, and electrical), and intumescent foams. Applications in which the present technology may be used include, but are not limited to, for example, belt strips; patch seals; tactile grips; vent seals; carpet backing; headliners; seating; run flat tires; sporting pads; wet suits; footwear; fabric backing; diapers; tapes; toys; luggage; ducting; floats; ear plugs; mattresses; furniture; automotive door, hood and trunk seals; and commercial and residential window and door seals.

Advantages of using this approach to introduce a physical foaming agent into an extrusion or molding process include but are not limited to manufacturing advantages to the properties of the foam formed by PFAC processes when compared to either chemical foaming agents or water injection processes.

Manufacturing of foamed articles may be easier for a multitude of reasons. For example, embodiments of the invention permit single stage extruders or molders to be used without difficulty or expensive modifications. Embodiments of the invention permit conventional extrusion or molding equipment to be used, including equipment having short L/D ratios such as 20:1 or 18:1. Embodiments of the invention permit the use of processing lines that do not require specialized configurations (such as injection pumps, special screws, etc.), so the same lines can be used to produce foamed articles and to produce a variety of materials and articles that may be unrelated to foam. In addition, embodiments of PFAC related processes are far less complex and thus easier to operate than conventional foam lines because usually associated auxiliary equipment need not be required. PFAC processes can be more robust and stable because of the reduced number of operating variables when compared to conventional foam lines (injection rates, injection pressures, process temperature effects, etc). PFACs can also be selected to be unaffected by static electricity, thereby ensuring consistent feeding in the hoppers of extrusion and molding equipment. Embodiments of the invention also permit lower melt pressures and mechanical energy to be used to foam equivalent articles when compared to conventional water injection processes—resulting in significant energy savings, for example savings of up to 25% or more.

Still further, PFAC foam densities can be more predictable than injection or thermal (chemical) reaction based systems. Foam densities may be controlled by varying the quantity of PFAC introduced into the system rather than by process conditions such as temperature profile, injection pressure, etc. Physical foaming agent concentration can be varied in the concentrate (masterbatch) itself to permit very finely tailored applications. Off-grade foamed articles can easily be ground and recycled. Unlike chemical blowing agents, no PFAC agent remains in the regrind because the physical blowing agent is vented upon foaming, when the PFAC vehicle is wholly incorporated into the polymer foam. In addition, unused compound can easily be recycled for use in non-foam applications by simply drying the blend.

When compared to foamed articles formed by water injection techniques or those formed by chemical foaming processes, the foamed articles formed by the claimed processes can have comparable or better physical properties. For example, in embodiments, the following advantages may be achieved:

Physical Properties (PFAC vs. Water Injection)

Compression Set—comparable at equivalent densities (ASTM D 395).

Tensile Strength—comparable at equivalent densities (ASTM D 1708-96).

Elongation—comparable at equivalent densities (ASTM D 1708-96).

100% Modulus—comparable at equivalent densities (ASTM D 1708-96).

Vacuum Water Absorption—PFAC shows slight improvement over water injection. (Derived from FBMS 4-1 & 4-2, GM9888P, and Chrysler MS -AK87)

Surface Ra—PFAC slightly smoother than water injection (AES TPE-0106, Rev. 5).

Foamed Article Dimensions—comparable at equivalent densities

PFAC vs. Chemical Foaming

Larger cell size (softer feel).

No odor or discoloration.

No hazardous environmental by products.

### EXAMPLES

The invention is illustrated with the following examples, which are intended to demonstrate, but not limit or restrict, embodiments of the invention. The physical properties of the samples are measured according to the following ASTM norms:

| | |
|---|---|
| Density: | ASTM D 792 |
| Compression Set | ASTM D 395 |
| Tensile Strength | ASTM D 1708-96 |
| Elongation | ASTM D 1708-96 |
| 100% Modulus | ASTM D 1708-96 |
| Vacuum Water Absorption | Per Physical Properties Description |
| Surface Ra | Per Physical Properties Description |

### Example 1

A Schaumex 60 mm (S-60) single screw extruder with the following configuration is used in the foaming examples:

60 mm barrel diameter.

L/D—30:1.

5 barrel-temperature zones.

3 downstream-tooling zones.

A 0.400″ omega bulb die.

A 0.260″ center pin with 2-3 PSI air.

Water injection pump.

Conveyor take-off with cooling nozzles (water or air).

A PFAC concentrate comprised of 50% by weight of ACCUREL®MP 100 (micro-porous hydrophilic polypropylene) is loaded with 50% by weight water in a standard drum tumbler.

SANTOPRENE® TPE (grade 121-68W228) is dry blended with the PFAC at 3 different levels—1.2% concentrate, 1.8% concentrate, and 2.2% concentrate.

The blends are then extruded in the Schaumex 60 mm single screw extruder at equivalent processing conditions (Table 1 & Table 2) and compared with water-injection foamed bulb gaskets (WIFBG) profiles at equivalent densities.

Density measurements are performed on the foamed samples. All profiles foam to a similar height at each of the densities. The foaming process is extremely stable using the PFAC noting that the extruder drive load, melt pressure, and melt temperature are very steady. Additionally the processing evaluation demonstrates that PFAC produced foam profiles at lower PSI for melt pressure at the injection point of the extruder; PFAC produced foam profiles at lower PSI for melt pressure at extruder discharge; and PFAC produced foam profiles at lower extruder motor load.

TABLE 1
Temperature Profile ° C.

| Sample | BZ-2 | BZ-3 | BZ-4 | BZ-5 | BZ-6 | Adapt. | Die | Head |
|---|---|---|---|---|---|---|---|---|
| WIFBG | 190 | 190 | 190 | 175 | 175 | 175 | 180 | 190 |
| WIFBG | 190 | 190 | 190 | 175 | 175 | 175 | 180 | 190 |
| PCK4040 | 190 | 190 | 190 | 175 | 175 | 175 | 180 | 190 |
| 1.2% PFAC | 190 | 190 | 190 | 175 | 175 | 175 | 180 | 190 |
| 1.8% PFAC | 190 | 190 | 190 | 175 | 175 | 175 | 180 | 190 |
| 2.2% PFAC | 190 | 190 | 190 | 175 | 175 | 175 | 180 | 190 |

TABLE 2
Mechanical

| | Melt Press | H₂O | Ext. | Melt Press | Melt | Screw | H₂O Inj | | Profile |
|---|---|---|---|---|---|---|---|---|---|
| Sample | At Inj - PSI | Bar | Load % | PSI | Temp | RPM | Rate | Density | Height |
| WIFBG | 2570 | 170 | 41 | 390 | 190° F. | 50 | 200 | .57 | 0.55″ |
| WIFBG | 2550 | 175 | 35 | 370 | 189 | 50 | 300 | .44 | 0.61″ |
| WIFBG | 2560 | 175 | 35 | 350 | 188 | 50 | 400 | .34 | 0.65″ |
| 1.2% PFAC | 2140 | — | 33 | 330 | 193 | 50 | — | .54 | 0.57″ |
| 1.8% PFAC | 2140 | — | 33 | 330 | 193 | 50 | — | .45 | 0.58″ |
| 2.2% PFAC | 2140 | — | 33 | 320 | 193 | 50 | — | .36 | 0.63″ |

### Example 2

Compression load deflection tests are performed with the standard method at 40% compression and deflection. A Monsanto 10 (T-10) Tensometer is setup to automatically compress and deflect three times for each sample. The height of the 150 mm T-Bar on top of the profile is not reset each time prior to compression and deflection. Therefore, the only reported value is the 3^{rd} deflection force in Newtons.

The PFAC-produced polymer profile's compression load deflection results are lower than those of the H₂O injection foamed profiles at the high density of ˜0.55 g/cc. However, at the lower densities of ˜0.45 g/cc and ˜0.35 g/cc, the compression load deflection results are significantly higher for the PFAC produced profiles than the H₂O injection foamed profiles.

TABLE 3
40% Compression Load Deflection

| Sample | Density | Newtons |
|---|---|---|
| WIFBG | 0.57 | 20.2 |
| WIFBG | 0.44 | 10.2 |
| WIFBG | 0.34 | 6.9 |
| 1.2% PFAC | 0.54 | 16.8 |
| 1.8% PFAC | 0.45 | 16.1 |
| 2.2% PFAC | 0.36 | 16.1 |

### Example 3

40% compression set (test method ISO 815:1991 (E)) is tested on the same samples. Height (inches) is measured using the distance between the top of the foamed profile to the bottom of the foot. Three points are measured on the 100 mm sample: Point A=25 mm, Point B=50 mm, and Point C=75 mm. Test method ISO 815:1991 (E), section 7.5.1 is used by removing the jigs from the aging oven and immediately removing the foamed profiles from the jigs. The foamed profiles are cooled for 30 minutes on a wooden bench and measured with a laser apparatus. The compression set results are computed as the following formula, (I-F)/(I-S) times 100=Compression Set %, or the initial height (I) minus the final height (F) divided by the initial height (I) minus the height of the spacer (S) or gap. The following tables (4 & 5) list the results.

All of the compression set results for 22 and 72 hours at 70° C. and 100° C. are similar for both the PFAC-produced profiles and H₂O injection foamed profiles.

TABLE 4

| Compression | | | Compression | | |
|---|---|---|---|---|---|
| Set for 22 Hrs 100° C. | | | Set for 22 Hrs 70° C. | | |
| Sample | Density | CSet (%) | Sample | Density | CSet (%) |
| WIFBG | 0.57 | 20.2 | WIFBG | 0.57 | 41 |
| WIFBG | 0.44 | 10.2 | WIFBG | 0.44 | 38 |
| WIFBG | 0.34 | 6.9 | WIFBG | 0.34 | 34 |
| 1.2% PFAC | 0.54 | 16.8 | 1.2% PFAC | 0.54 | 41 |
| 1.8% PFAC | 0.45 | 16.1 | 1.8% PFAC | 0.45 | 38 |
| 2.2% PFAC | 0.36 | 16.1 | 2.2% PFAC | 0.36 | 35 |

TABLE 5

| Compression | | | Compression | | |
|---|---|---|---|---|---|
| Set for 72 Hrs 100° C. | | | Set for 72 Hrs 70° C. | | |
| Sample | Density | CSet (%) | Sample | Density | CSet (%) |
| WIFBG | 0.57 | 51 | WIFBG | 0.57 | 45 |
| WIFBG | 0.44 | 50 | WIFBG | 0.44 | 43 |
| WIFBG | 0.34 | 43 | WIFBG | 0.34 | 36 |
| 1.2% PFAC | 0.54 | 50 | 1.2% PFAC | 0.54 | 44 |
| 1.8% PFAC | 0.45 | 47 | 1.8% PFAC | 0.45 | 42 |
| 2.2% PFAC | 0.36 | 45 | 2.2% PFAC | 0.36 | 38 |

### Example 4

The foam surface quality test is a modified version of the surface smoothness measurement test TPE-0106 Rev.3 (Advanced Elastomer Systems) performed with the use of a Surface Profilometer. The Ra, Ry, and Surface Index values are obtained for each foam profile. The following is a breakdown of each surface roughness parameter obtained from the current standard Federal Product Surfanalyzer System 4000.

Ra=roughness average is the arithmetic average of roughness irregularities measured from a mean line within the sample length. Ra (approx.) equals (Y1+Y2+Y3)/n.

Ry=Maximum peak to valley height measured parallel to the mean line. This parameter is the most sensitive indicator of high peaks and deep scratches.

Surface Index=Ra+0.10 (Ry).

Table 6 lists the results.

The Surface Index and Ra results are lower for the PFAC-produced foam profiles at the high density ˜0.55 g/cc. The Surface Index and Ra results at ˜0.45 g/cc are similar. The Surface Index and Ra results are slightly higher for the PFAC-produced foam profiles at the low density of ˜0.35 g/cc.

TABLE 6

| Surface Profilometer | | | Surface Index | | |
|---|---|---|---|---|---|
| Sample | Density | Ra | Sample | Density | Surface Index |
| WIFBG | 0.57 | 5 | WIFBG | 0.57 | 8 |
| WIBG | 0.44 | 6 | WIFBG | 0.44 | 10 |
| WIFBG | 0.34 | 6 | WIFBG | 0.34 | 10 |
| 1.2% PFAC | 0.54 | 3 | 1.2% PFAC | 0.54 | 6 |
| 1.8% PFAC | 0.45 | 6 | 1.8% PFAC | 0.45 | 10 |
| 2.2% PFAC | 0.36 | 7 | 2.2% PFAC | 0.36 | 12 |

### Example 5

The foam micro-tensile test is a modified version of ASTM D 1708-96. A Monsanto 10 (T-10) Tensometer is used to test the foamed profiles. Standard setup for tensile testing is used. The foot (base) of the foamed profile is removed and only the bulb section of the foamed profile is tested. The following table (7) shows the micro-tensile results of Ultimate Tensile Strength (UTS), Ultimate Elongation (UE), and 100% Modulus (M10O) from the profiles:

The UTS and UE results are similar at ˜0.45 g/cc and ˜0.35 g/cc densities. The UTS and UE results demonstrate higher results for the H₂O injection foamed profiles at the high density of ˜0.55 g/cc. The M100 results are similar at ˜0.55 g/cc and ˜0.45 g/cc densities. At the low density of ˜0.35 g/cc, the M100 results are higher for the H₂O injection foamed profiles.

TABLE 7
Micro-Tensile

| | | UTS | UE | M100 |
|---|---|---|---|---|
| Sample | Density | (PSI) | (%) | (PSI) |
| WIFBG | 0.57 | 340 | 275 | 210 |
| WIFBG | 0.44 | 280 | 290 | 175 |
| WIFBG | 0.34 | 230 | 260 | 160 |
| 1.2% PFAC | 0.54 | 290 | 250 | 195 |
| 1.8% PFAC | 0.45 | 285 | 290 | 175 |
| 2.2% PFAC | 0.36 | 210 | 275 | 125 |

### Example 6

The vacuum and atmospheric water absorption test is a modified version of the General Motors Specification GM9888P, Chrysler Corporation Vehicle Engineering Standard No. MS-AK87, and Ford Motors Company Engineering Material Specification ESB-M2D189-A. The sample size is 250 mm, and each end is marked at 25 mm. The foamed profile is flexed into a “U” shape and placed inside a vacuum chamber with the marked ends 25 mm above the water line. For atmospheric water absorption, the profile is removed; air dried, and reweighed after 24 hours. For vacuum water absorption, the vacuum chamber's pressure above the water surface is reduced to 10 mm for 5 minutes, then the profile is allowed to stand for 5 more minutes at atmospheric conditions. After that the profile is removed, air dried and reweighed. Both methods utilize the following formula for water absorption:

$$Water Absorption ( \% ) = \frac{( Final weight - Initial Weight ) \times 100 }{( 0.8 ) \times ( Initial Weight )}$$

The vacuum water absorption test results for the ˜0.35 g/cc density PFAC profiles and H₂O injection foamed profiles are similar. The vacuum water absorption test results for the PFAC profiles at ˜0.55 g/cc and ˜0.45 g/cc densities are lower that the H₂O injection foamed profile test results.

The atmospheric water absorption test results for the H₂O injection foamed profiles at all densities are lower that the PFAC profiles.

TABLE 8

| Vacuum Water Absorption | | | Atmospheric Water Absorption | | |
|---|---|---|---|---|---|
| | | Weight | | | Weight |
| Sample | Density | Percent | Sample | Density | Percent |
| WIFBG | 0.57 | 1.10 | WIBG | 0.57 | 0.96 |
| WIFBG | 0.44 | 0.58 | WIFBG | 0.44 | 1.29 |
| WIFBG | 0.34 | 0.58 | WIFBG | 0.34 | 1.68 |
| 1.2% PFAC | 0.54 | 0.60 | 1.2% PFAC | 0.54 | 1.26 |
| 1.8% PFAC | 0.45 | 0.46 | 1.8% PFAC | 0.45 | 1.94 |
| 2.2% PFAC | 0.36 | 0.60 | 2.2% PFAC | 0.36 | 2.51 |

What is claimed is:

1. A process for preparing a foam of a thermoplastic material, comprising:
mixing a physical foaming agent concentrate, comprising a solid carrier vehicle loaded with at least one physical foaming agent, with at least one thermoplastic material to form a mixture;
heating the mixture to a temperature above the melting point of the at least one thermoplastic material and at which the physical foaming agent concentrate releases the at least one physical foaming agent; and
releasing the heated mixture to reduced-pressure conditions.

2. The process according to claim 1, wherein the solid carrier vehicle is in the form of a powder or pellets.

3. The process according to claim 1, wherein the at least one thermoplastic material comprises a thermoplastic elastomer.

4. The process according to claim 1, wherein the at least one thermoplastic material comprises at least one thermoplastic vulcanizate.

5. The process according to claim 1, wherein the at least one thermoplastic material is selected from the group consisting of olefins, polyolefins, TPVs, styrenics, metallocene compositions, SEBs, SEPS, SBS, polyvinyl chlorides, thermoplastic urethanes, COPE, COPA, and fluoroelastomers, and mixtures thereof.

6. The process according to claim 1, wherein the step of mixing the physical foaming agent concentrate with at least one thermoplastic material to form a mixture further comprises mixing at least one additional ingredient.

7. The process according to claim 1, wherein the step of mixing the physical foaming agent concentrate with at least one thermoplastic material to form a mixture further comprises mixing at least one additional ingredient selected from the group consisting of fillers, waxes, stabilizers and colorants.

8. The process according to claim 1, wherein the physical foaming agent concentrate releases the physical foaming agent at a temperature within the range of 0-350° C.

9. The process according to claim 1, wherein the physical foaming agent concentrate releases the physical foaming agent at a temperature within the range of 10-350° C.

10. The process according to claim 1, wherein the physical foaming agent concentrate releases the physical foaming agent at a temperature within the range of 80°-250° C.

11. The process according to claim 1, wherein the at least one physical foaming agent is selected from the group consisting of water, low boiling point hydrocarbons, HFC and CFC.

12. The process according to claim 11, wherein the at least one physical foaming agent is water.

13. The process according to claim 1, wherein the amount of the at least one physical foaming agent released is in the range of 0.1-63% by weight relative to the total weight of the mixture.

14. The process according to claim 1, wherein the amount of the at least one physical foaming agent released is in the range of 0.1-50% relative to the total weight of the mixture.

15. The process according to claim 1, wherein the amount of the at least one physical foaming agent released is in the range of 0.1-20% relative to the total weight of the mixture.

16. The process according to claim 1, wherein the process is carried out in an extruder with a L/D ratio from about 18:1 to about 42:1.

17. The process according to claim 1, wherein the process is carried out in an extruder with a L/D ratio from about 20:1 to about 32:1.

18. The process according to claim 1, wherein the solid carrier vehicle is a liquid absorbing material.

19. The process according to claim 1, wherein the solid carrier vehicle comprises pellets or powder formed of super-absorbent polymers, organic fillers or high surface area polymeric materials.

20. The process according to claim 1, wherein the solid carrier vehicle comprises pellets or powder formed of porous or microporous polymers.

21. The process according to claim 20, wherein the porous or microporous polymers are selected from the group consisting of EVA, high density polyethylene, low density polyethylene, LLDPE, polypropylene, polystyrene, PET and polyamide.

22. The process according to claim 19, wherein the at least one super-absorbent polymer is selected from the group consisting of polyacrylates and polyacrylamides.

23. The process according to claim 1, wherein the solid carrier vehicle comprises at least one organic filler.

24. The process according to claim 1, wherein the solid carrier vehicle comprises at least one inorganic filler.

25. The process according to claim 1, wherein the solid carrier vehicle is hydrophilic.

26. The process according to claim 1, wherein the solid carrier vehicle is hydrophobic.

27. A foamed thermoplastic article, produced by a process according to claim 1.

28. A physical foaming agent concentrate, comprising a solid carrier vehicle loaded with at least one physical foaming agent in a form that can be mixed with at least one thermoplastic material to form a mixture and heated to release the at least one physical foaming agent from the vehicle.

29. The concentrate according to claim 28, wherein the solid carrier vehicle is in the form of a powder or pellets.

30. The concentrate according to claim 28, wherein the at least one physical foaming agent concentrate further comprises at least one additional ingredient.

31. The concentrate according to claim 30, wherein the at least one additional ingredient is selected from the group consisting of fillers, waxes, stabilizers and colorants.

32. The concentrate according to claim 28, wherein the at least one physical foaming agent is selected from the group consisting of water, low boiling point hydrocarbons, HFC and CFC.

33. The concentrate according to claim 32, wherein the at least one physical foaming agent is water.

34. The concentrate according to claim 28, wherein the amount of the at least one physical foaming agent released is in the range of 0.1-63% by weight relative to the total weight of the mixture.

35. The concentrate according to claim 28, wherein the amount of the at least one physical foaming agent released is in the range of 0.1-50% by weight relative to the total weight of the mixture.

36. The concentrate according to claim 28, wherein the amount of the at least one physical foaming agent released is in the range of 0.1-20% by weight relative to the total weight of the mixture.

37. The concentrate according to claim 28, wherein the solid carrier vehicle is a liquid absorbing material.

38. The concentrate according to claim 28, wherein the solid carrier vehicle comprises pellets or powder formed of super-absorbent polymers, organic fillers or high surface area polymeric materials.

39. The concentrate according to claim 28, wherein the solid carrier vehicle comprises pellets or powder formed at least one of porous or microporous polymers.

40. The concentrate according to claim 39, wherein the at least one porous or microporous polymers is selected from the group consisting of EVA, high density polyethylene, low density polyethylene, LLDPE, polypropylene, polystyrene, PET and polyamide.

41. The concentrate according to claim 38, wherein the at least one super-absorbent polymer is selected from the group consisting of polyacrylates and polyacrylamides.

42. The concentrate according to claim 28, wherein the solid carrier vehicle comprises at least one organic filler.

43. The concentrate according to claim 28, wherein the solid carrier vehicle comprises at least one inorganic filler.

44. The concentrate according to claim 28, wherein the solid carrier vehicle is hydrophilic.

45. The concentrate according to claim 28, wherein the solid carrier vehicle is hydrophobic.

46. The concentrate according to claim 28, wherein the at least one physical foaming agent is released at a temperature within the range of 0-350° C.

47. The concentrate according to claim 28, wherein the at least one physical foaming agent is released at a temperature within the range of 10-350° C.

48. The concentrate according to claim 28, wherein the at least one physical foaming agent is released at a temperature within the range of 80°-250° C.
